(19) United States
(12) Patent Application Publication
(10) Pub. No.: US 2012/0061312 A1
(43) Pub. Date: Mar. 15, 2012

(54) REUSABLE FILTER CARTRIDGE

(75) Inventors: Louis M. Busick, Westerville, OH (US); John M. Kucharik, Chagrin Falls, OH (US)

(73) Assignee: LVD ACQUISITION, LLC, Columbus, OH (US)

(21) Appl. No.: 12/879,539

(22) Filed: Sep. 10, 2010

(51) Int. Cl. B01D 35/02; B01D 29/23; B01D 29/085

(52) U.S. Cl. 210/471; 210/479; 210/474

(57) ABSTRACT

Described is a filter cartridge having a cup shape that can be filled with a filtering material, and placed in a filtering device such as a water pitcher. The filter cartridge has a base, a side wall, and a flange defining the cup shape of the filter cartridge. A removable mesh insert may be affixed atop the flange, allowing replacement of the filtering material.

### TECHNICAL FIELD

The present invention relates generally to a reusable filter cartridge for a water pitcher. More particularly, the invention relates to a reusable filter cartridge, which can be filled with granular filter material, in the shape of a cup having an open top and at least one outlet aperture for filtering liquids, particularly water.

### BACKGROUND

Ion exchangers and activated charcoal are typically used in providing consumers with a means to filter water. In general, known filter cartridges have a central longitudinal axis and are arranged vertically such that a lid is fixed or welded at the top and the outlet apertures are at the bottom when installed in a water pitcher or other similar device. The water to be filtered flows into the filter cartridge, through the inlets in the lid, passing over the filtering media and exits the filter cartridge through the outlet apertures. The filer cartridges are placed in a water pitcher or other similar device so that unfiltered water, such as standard tap water, is forced through the filter cartridge and is collected.

Filter cartridges are known which have narrow slits forming the inlet and outlet apertures, as these are easy to manufacture using injection molding techniques. Injection molding plastics are preferably used for such filter means. Furthermore, sieve fabrics may be placed in the filter cartridge to prevent the filtering material from escaping through the inlet or outlet apertures.

The use of filter cartridges helps to reduce consumer waste. Instead of consumers purchasing bottled water, traditional filter cartridges may provide the consumer with their filtered water needs. However, traditional filter cartridges need to be replaced once the filtering material has lost its effectiveness. Once the filtering material becomes ineffective, the filter cartridge is removed from the filtering device and thrown away. While this does help to reduce waste, as opposed to the use of bottle water, the spent filter cartridges still take up space in landfills.

### SUMMARY OF THE INVENTION

The reusable filter cartridge described herein provides a means for consumers to filter liquids, while protecting the environment. Unlike traditional filter cartridges, the exemplary embodiments described herein allow the consumer to simply replace the filtering material found within the filter cartridge rather than disposing of a used filter cartridge.

To allow the filter cartridge to be reusable, the filter cartridge may have a base divided into chambers. The bottom of each chamber may have an outlet aperture. The outlet aperture may be circular and have a plurality of pores therein. The pores in the outlet aperture allow the filtered water to escape the filter cartridge. To prevent the filtering material from clogging the pores, a fabric sieve may be placed in each chamber. The side walls, forming the cup shape of the filtering cartridge, extend upward from the base and terminate in a flange. A notch extending into the interior of the filter cartridge may be formed into the side wall. The notch may assist in positioning the filter cartridge when inserted into a filtering device. The flange may have an interior groove and an exterior channel both running the circumference of the flange. An o-ring, or other similar compression member, may be placed into the exterior channel in the flange to form a water tight seal between the filtering cartridge and the filter device.

A mesh insert is designed to fit atop the flange. The mesh insert has a ring shape having an internal cavity. The cavity is covered by a mesh integral to the ring. The ring has a track running the circumference of the ring designed to nest into the interior groove in the flange. This tongue and groove design allows the mesh insert to be removably inserted into the flange.

To use embodiments of the reusable water filter described herein a consumer fills the filter cartridge with filtering material such as activated charcoal. The mesh insert is then snapped into the flange. The filter cartridge is then placed into a water filtering device such as a water pitcher. When the useful life of the activated charcoal has been exhausted, instead of throwing the used filter cartridge away, the consumer may merely replace the filtering material. This is accomplished by removing the filter cartridge from the filtering device and further removing the mesh insert from the flange. The used activated charcoal is dumped out of the filter cartridge and new activated charcoal is placed in the filter cartridge. The mesh insert is again inserted into the flange and the filter cartridge is placed in the filter device until the activated charcoal needs changed again.

Traditional filter cartridges have a lid molded onto the cup portion of the filter cartridge preventing consumers from replacing the filtering material. This ability to replace the filtering material without the need to dispose of the filtering cartridge greatly decreases the amount of waste produced over conventional filtering cartridges.

### BRIEF DESCRIPTION OF THE DRAWINGS

Novel features and advantages of the present invention, in addition to those mentioned above, will become apparent to those skilled in the art from a reading of the following detailed description in conjunction with the accompanying drawings wherein identical reference characters refer to identical parts and in which:

FIG. 1 is a top view of an exemplary embodiment of the filter cartridge;

FIG. 2 is a side cross-sectional view of an exemplary embodiment of the filter cartridge taken along line 2-2 of FIG. 1;

FIG. 3 is a top perspective view of an exemplary embodiment of the filter cartridge's removable mesh insert; and

FIG. 4 is a top perspective view of an exemplary embodiment of the filter cartridge including the removable mesh insert.

### DETAILED DESCRIPTION OF THE EXEMPLARY EMBODIMENT(S)

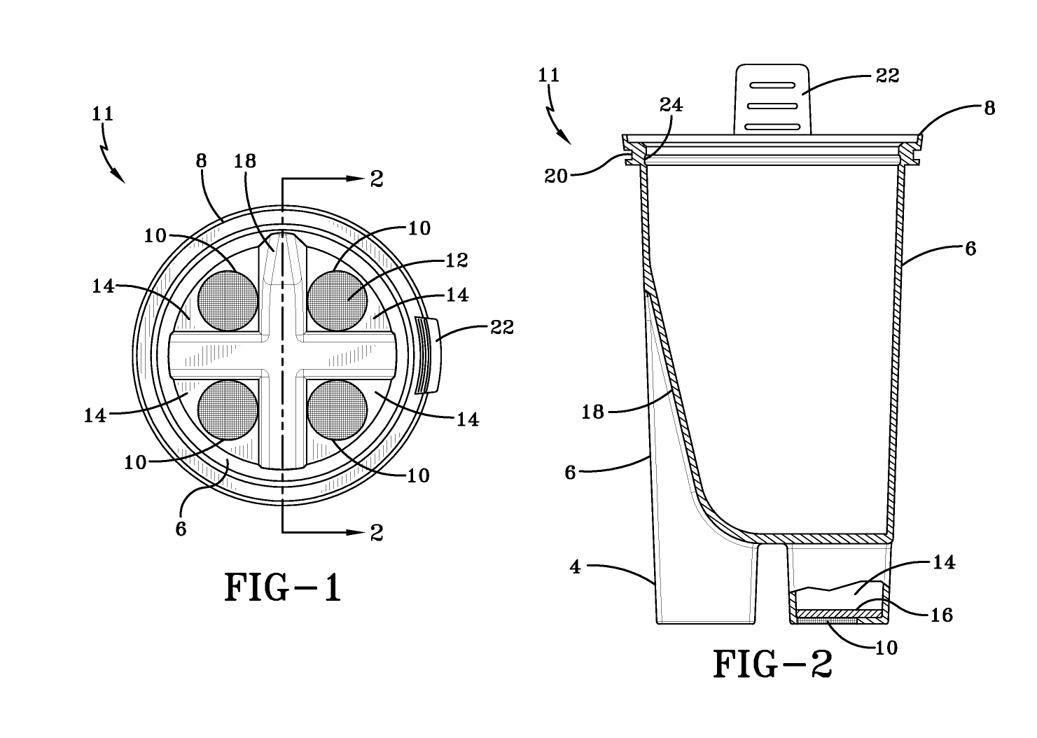

FIG. 1 illustrates an exemplary embodiment of the filter cartridge 11 having a cup shape open at the top. The body of the filter cartridge 11 having a base 4 (shown in FIG. 2), side wall 6, and a flange 8. In the base 4 of the filter cartridge 11 are located at least one outlet aperture 10. As shown in the embodiment illustrated in FIG. 1, the outlet apertures 10 may be circular in shape. However, it is to be noted that in other embodiments the outlet apertures 10 may be square, triangular, or any other shape whereby a liquid may escape the filter cartridge. The outlet apertures 10 each contain a plurality of pores 12 although the plurality of pores 12 in FIG. 1 are square, other shapes such as circles or triangles are contemplated. The pores 12 have a dimension of about 0.3 mm square, or other dimension sufficient to aid in maintaining the filtering material within the filter cartridge 11. In the exemplary embodiment each outlet aperture 10 has approximately 265 pores 12 per outlet aperture 10.

The base 4 of the filter cartridge 11 may be divided into a plurality of chambers 14. As illustrated in FIG. 1, the material used to form the filter cartridge 11 may be manufactured so as to extend into the interior of the filter cartridge 11, bisecting the base 4 and forming the plurality of chambers 14, wherein each chamber 14 contains an outlet aperture 10. To aid in filtration and to prevent the filtering material from escaping the filter cartridge 11 and to prevent the filtering material from clogging the pores 12, a fabric sieve (shown in FIG. 2) 16 may be placed into each chamber 14. The chambers 14 and the divisions therebetween may also be used to control the rotary position of the filter cartridge 11 inside a filtering device.

A side wall 6 extends upward from the base 4 increasing in circumference in a conical manner, terminating in a flange 8. A notch 18 may be located along the side wall 8 and extend into the interior of the filter cartridge 11. The notch 18, like the chambers 14, may be used to control the position of the filter cartridge 11 when inserted into the filtering device by way of a loose tongue and groove engagement with the filtering device.

FIG. 2 illustrates a cross-sectional view of an exemplary embodiment of the filter cartridge 11. As shown in FIG. 2, the side wall 6 extends upward from the base 4 and terminates in a flange 8. A channel 20 is provided within the exterior of the flange 8 for receiving an o-ring or other similar device for providing a water tight seal between the filter cartridge 11 and the filtering device. The flange 8 may be tapered so as to provide more secure fit between the filter cartridge 11 and the filtering device. In the embodiment illustrated in FIG. 2, the flange 8 may have a circumference greater than the circumference of the side wall 6. The water tight seal formed between the filter cartridge 11 and a filtering device, such as a water pitcher, forces the water to be filtered to pass through the filter cartridge 11.

To allow the consumer to easily manipulate the filter cartridge 11 into and removal from the filtering device a tab 22 is molded into the flange 8. The tab 22 extends upward from the flange 8 and may be patterned to provide a gripping surface for the consumer. Although, the exemplary embodiment in FIG. 2 contemplates forming the water tight seal between the filter cartridge 11 and the filtering device with an o-ring within the channel 20, other exemplary embodiments may have a flange 8 comprising exterior threads corresponding to threads inside the filtering device to provide a water tight seal.

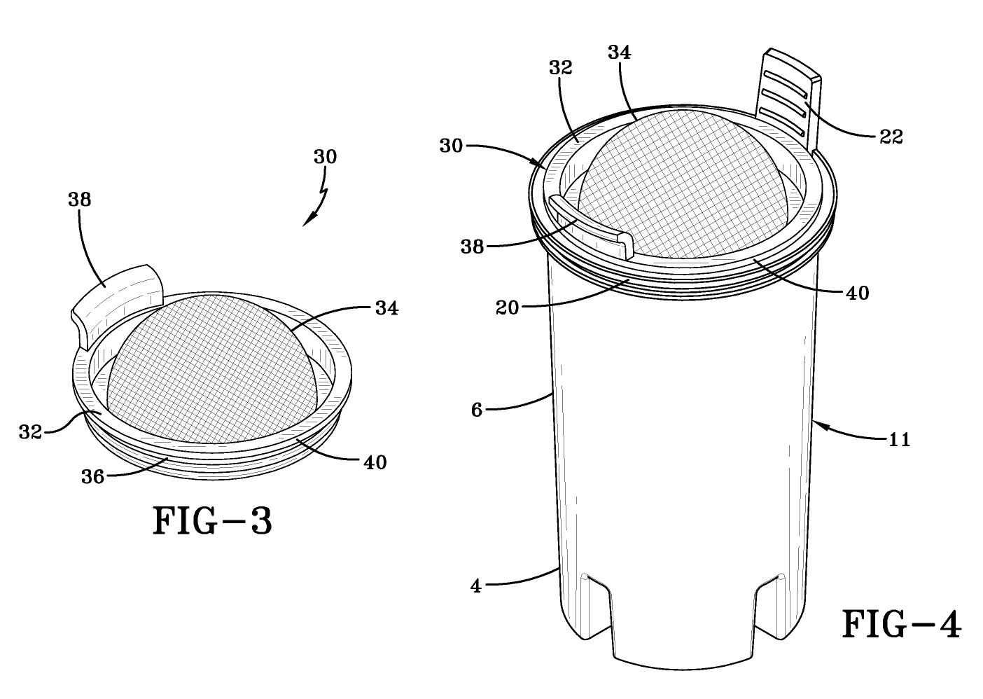

The interior portion of the flange 8 includes a groove 24 running the circumference of the flange 8. The groove 24 is designed to form a seal with the removable mesh insert 30 (shown in FIG. 3) when brought into a complementary engagement as described herein and shown in FIG. 4.

FIG. 3 illustrates a top perspective view of an exemplary embodiment of the filter cartridge's removable mesh insert 30. The mesh insert 30 comprises a ring 32 having a cavity therein. The cavity is covered with a plastic mesh 34 that is integral to the ring 32. The mesh 34 is formed so as to extend upward beyond the ring 32 away from the interior of the filter cartridge 11. In exemplary embodiments, the mesh 34 may be 100 mesh or another similar size sufficient to allow the unfiltered water to enter the filter cartridge 11 while preventing the escape of the filtering material, such as activated charcoal.

A track 36 is molded into the exterior circumference of the ring 32. The track is designed to nest into the groove 24 around the interior of the flange 8 when the removable mesh insert 30 is brought into complimentary engagement with the filter cartridge 11. In this manner, the removable mesh insert 30 may be snapped into place atop the filter cartridge 11 preventing the filtering material contained within the filter cartridge 11 from escaping. In other exemplary embodiments, the ring 32 and the interior of the flange 8 may be threaded so as to provide a secure attachment. As with the flange 8, a tab 38 is molded into the ring 32 of the mesh insert 30 and extends upward to provide the consumer to easily insert and remove the mesh insert 30. To further assist the consumer in correctly affixing the mesh insert 30 atop the flange 8, the ring 32 may have a lip portion 40 that when the mesh insert 30 is brought into complementary engagement with the flange 8, rests against the flange 8 to ensure the track 36 and groove 24 are aligned.

The filter cartridge 11 as shown in FIG. 4 can be fitted into a filtering device, such as a pitcher (not shown), and used by consumers. As water is poured into the filtering device, the water passes through the mesh 34 portion of the mesh insert 30 into the filter cartridge 11 and flows through the filtering material contained within the interior of the filter cartridge 11. The filtered water then exits the filter cartridge 11 through the pores 12 in the apertures 10 which also retains the filter material. After the useful life of the filtering material has been exhausted, the end consumer may remove the filter cartridge 11 from the filtering device, remove the mesh insert 30 and remove the spent filtering material and replace it with new filtering material without the need to dispose of the entire filter cartridge 11.

Any combination of the exemplary embodiments described herein may be used herein. While certain exemplary embodiments of the present invention are described in detail above, the scope of the invention is not to be considered limited by such disclosure, and modifications are possible without departing from the spirit of the invention as evidenced by the following claims:

What is claimed is:

1. A filter cartridge for filtering liquid in a filtering device, comprising:
a base divided into chambers, wherein each chamber includes at least one aperture, the at least one aperture having a plurality of pores having a dimension of approximately 0.3 millimeters square;
a fabric sieve placed in each chamber covering the at least one aperture contained therein;
a side wall extending upward from the base conically and terminating at a flange, said flange having a larger circumference then said side wall, the flange having a groove formed into the interior circumference of the flange and a channel disposed in the exterior circumference of the flange, said channel having an o-ring disposed therein for forming a water-tight seal between said filter cartridge and the filtering device;
a notch extending upward along the side wall and into the interior of the filter cartridge;
a mesh insert affixed atop said flange, said mesh insert having a ring defining an internal cavity;
a mesh covering integral with said ring covering said cavity; and
a track formed around the exterior circumference of the ring; wherein when the mesh insert is brought into complimentary engagement with said flange, said track is nested within said groove forming a seal between said flange and said mesh insert.

2. The filter cartridge of claim 1, further comprising a first tab extending upward from the ring.

3. The filter cartridge of claim 1, further comprising a second tab extending upward from the flange.

4. The filter cartridge of claim 1, wherein the mesh is approximately 100 mesh.

5. A filter cartridge for filtering liquid, comprising:
a base divided into chambers, wherein each chamber includes at least one aperture;
a side wall extending upward from the base conically and terminating in a flange, the flange having a first groove and a second groove disposed therein, said first groove is disposed in the exterior circumference of the flange and the second groove is disposed in the interior circumference of the flange; and
a removable mesh insert having a track, wherein when said mesh insert and flange are brought into removable complimentary engagement said track is nested into said second groove forming a seal between said mesh insert and said flange.

6. The filter cartridge of claim 5, wherein each at least one aperture includes a plurality of pores, wherein each of said plurality of pores is approximately 0.3 millimeters square.

7. The filter cartridge of claim 5, wherein each at least one aperture comprises approximately 265 pores.

8. The filter cartridge of claim 5, further comprising a fabric sieve located in each chamber covering the at least one aperture contained therein.

9. The filter cartridge of claim 5, further comprising a notch extending upward from the base along the side wall and extending into the interior of the filter cartridge, said notch providing rotary control of the filter cartridge when inserted into the filtering device.

10. The filter cartridge of claim 5, wherein said flange has a greater circumference then the circumference of the side wall.

11. The filter cartridge of claim 5, further comprising an o-ring disposed within the first groove to form a water tight seal between said flange and said filtering device.

12. The filter cartridge of claim 5, wherein said removable mesh insert further comprises a ring defining an internal cavity.

13. The filter cartridge of claim 12, further comprising a mesh integral to said mesh insert covering said internal cavity.

14. A filter cartridge for filtering liquid in a filtering device, comprising:
a base including at least one aperture;
a side wall extending conically upward from said base terminating in a flange; and
a removable mesh insert detachable affixed atop the flange.

15. The filter cartridge of claim 14, wherein the flange comprises a first groove and a second groove, said first groove is disposed along the exterior circumference of said flange and said second groove is disposed along the interior circumference of said flange.

16. The filter cartridge of claim 15, further comprising an o-ring disposed within said first groove providing a water tight seal between said filter cartridge and said filtering device.

17. The filter cartridge of claim 14, wherein said removable mesh insert includes a ring having a track molded along the exterior surface, said track nesting into said second groove when said mesh insert is brought into complimentary engagement with said flange.

18. The filter cartridge of claim 17, wherein said ring defines an internal cavity covered by a mesh integral with said ring.

19. The filter cartridge of claim 14, wherein said base is divided into chambers, each chamber having the at least one aperture.

20. The filter cartridge of claim 17, further comprising a tab extending upward from said ring.
